(19) United States
(12) Patent Application Publication
(10) Pub. No.: US 2017/0372133 A1
(43) Pub. Date: Dec. 28, 2017

(54) METHOD AND SYSTEM FOR DETERMINING BODY POSITION OF AN OCCUPANT

(71) Applicant: POINTGRAB LTD., HOD HASHARON (IL)

(72) Inventors: EYAL FRISHMAN, HOD HASHARON (IL); ORA ZACKAY, HOD HASHARON (IL); JONATHAN LASERSON, TEL-AVIV (IL)

(21) Appl. No.: 15/464,569

(22) Filed: Mar. 21, 2017

(30) Foreign Application Priority Data
Jun. 22, 2016 (IL) 246387

(51) Int. Cl. G06K 9/00

(52) U.S. Cl. CPC G06K 9/00369; G06K 9/00771

(57) ABSTRACT

A system and method are provided for determining a body position of an occupant form an image, based on the shape of the occupant and based on a visual surrounding of the shape of the occupant in the image.

### FIELD OF THE INVENTION

The present invention relates to the field of scene analysis using computer vision techniques. Specifically, the invention relates to determining a body position of an occupant in an image.

### BACKGROUND

Computer vision is sometimes used to analyze an imaged space and to detect occupants in the space. Determining the body position (e.g., standing or sitting) of an occupant may be useful in enhancing analysis of an imaged scene.

There exist systems that use one or more cameras to monitor a space or area. Some of these systems use cameras located in a ceiling of a monitored area providing overhead tracking of occupants. However, in the case of overhead tracking the shapes of people's bodies are highly deformable and thus not easily understood by current image analysis techniques. Consequently, these systems do not accurately construe and analyze an imaged scene.

### SUMMARY

Embodiments of the invention provide a method and system for accurate analysis of an imaged scene.

In one embodiment an occupant's body position in an image is determined based on the shape of the occupant and based on the visual surrounding of the shape of the occupant in the image.

In additional embodiments a body position of an occupant in an image of a space is determined and the presence or absence of a predetermined object in the image is also determined. An output is then generated based on the determined body position of the occupant and based on the determination of presence (or absence) of the predetermined object in the image.

Embodiments of the invention facilitate automatic interpretation of an imaged scene which eliminates the need for a human operator viewing the images, thereby providing a solution for monitoring a space while securing the privacy of occupants in the space.

In one embodiment a system and method include detecting a shape of an occupant in an image of a space; determining a body position of the occupant based on the shape of the occupant and based on a visual surrounding of the shape of the occupant in the image; and generating an output based on the body position of the occupant.

In another embodiment a system and method include determining a body position of an occupant in an image of a space; determining presence of a predetermined object in the image; and generating an output based on the determined body position of the occupant and based on the determination of presence of the predetermined object in the image.

In another embodiment a system and method include detecting an occupant in an image of a space; detecting an object in the image; and generating an output based on proximity of the occupant to the object.

In yet another embodiment a system and method include detecting a shape of an occupant and detecting an object in an image; determining a distance between the object and the shape of the occupant; and determining the body position of the occupant based on the shape of the occupant and on the distance.

In yet another embodiment a system and method include detecting a first body position of an occupant in at least one image of a space; detecting a change from the first body position to a second body position in a subsequent image of the space; and generating an output based on the detection of the change.

### BRIEF DESCRIPTION OF THE DRAWINGS

The invention will now be described in relation to certain examples and embodiments with reference to the following illustrative drawing figures so that it may be more fully understood. In the drawings:

FIG. 1 is a schematic illustration of a system operable according to embodiments of the invention;

FIG. 2 is a schematic illustration of a method for determining a body position of an occupant in a space, according to an embodiment of the invention;

FIG. 3 is a schematic illustration of a method for determining a body position of an occupant based on detection of an object in the image, according to an embodiment of the invention;

FIGS. 4A and 4B schematically illustrate methods for analysis of images while detecting a change of body position, according to embodiments of the invention;

FIG. 5 schematically illustrates a method for detecting a change of body position by detecting motion in images, according to an embodiment of the invention;

FIGS. 6A and 6B schematically illustrate methods based on determining a body position of an occupant and determining presence of an object in the image, according to embodiments of the invention;

FIGS. 7A and 7B schematically illustrate methods based on proximity and/or location of an occupant in a predetermined body position, relative to an object in an image, according to embodiments of the invention; and

FIG. 8 schematically illustrates a method based on detection of an occupant and a predetermined object in an image of a space, according to embodiments of the invention.

### DETAILED DESCRIPTION

Embodiments of the invention provide methods and systems for analysis of an imaged scene. In the following description the term “occupant” refers to a typically transient body in a space, such as a human and/or animal and/or inanimate object such as a vehicle. The term “object” usually refers to a more permanent body in the space, such as furniture or equipment or other fixtures in the space. In some cases, “occupants” have deformable shapes whereas “objects” have rigid shapes.

In some embodiments of the invention analysis of an imaged scene includes automatic detection of a shape of an occupant from an image and using the detected shape to determine an occupant's body position (e.g., standing, sitting, squatting, lying, etc.). In some embodiments the shape of the occupant and the visual surrounding of the occupant (or of the shape of the occupant) are used to determine an occupant's body position.

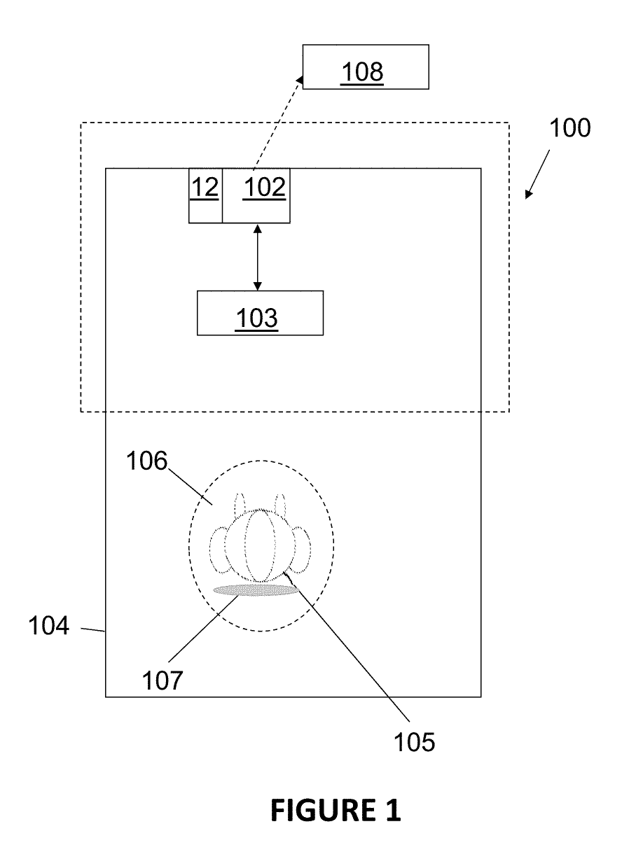

An example of a system operable according to embodiments of the invention is schematically illustrated in FIG. 1.

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” “detecting”, “identifying” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

In one embodiment a system 100 includes an image sensor 103 which may be part of a camera monitoring a space such as a room 104 or portion of the room 104. In one embodiment the camera is a 2D camera. In some embodiments the image sensor 103 is configured to obtain 2D top view images of the space. For example, image sensor 103 may be part of a ceiling mounted 2D camera.

The image sensor 103 may be associated with a processor 102 and a memory 12. Processor 102 runs algorithms and processes to analyze an imaged scene, e.g., to detect an occupant and/or other objects in images obtained from image sensor 103. Shape detection algorithms (including machine learning processes) may be used to detect a shape of an occupant and/or other object in the images. The processor 102 may output data or signals which may be used to provide information and/or for controlling devices, e.g., device 108.

The processor 102 may be in wired or wireless communication with devices and other processors. For example, output from processor 102 may trigger a process within the processor 102 or may be transmitted to another processor or device to activate a process at the other processor or device.

In some embodiments a counter, which may be part of processor 102 or may be part of another processor that accepts input from processor 102, is used to count occupants in the space.

Processor 102 may include, for example, one or more processors and may be a central processing unit (CPU), a digital signal processor (DSP), a microprocessor, a controller, a chip, a microchip, an integrated circuit (IC), or any other suitable multi-purpose or specific processor or controller.

Memory unit(s) 12 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

Images obtained by the image sensor 103 may be analyzed by a processor, e.g., processor 102. For example, image/video signal processing algorithms and/or shape detection and/or motion detection algorithms and/or machine learning processes may be run by processor 102 or by another processor.

According to some embodiments images may be stored in memory 12. Processor 102 can apply image analysis algorithms, such as known motion detection and shape detection algorithms and/or machine learning processes in combination with methods according to embodiments of the invention to analyze an imaged scene, e.g., to determine a body position (e.g., standing, sitting, lying) of an occupant from images of the space.

In one embodiment an image of the room 104 or part of the room obtained by image sensor 103 is analyzed by processor 102 to detect a shape of an occupant 105 and to detect the visual surrounding 106 of the occupant (or shape of the occupant) in the image.

In one embodiment the visual surrounding of the occupant includes parts of the image that surround the occupant 105 (e.g., parts of the image that are at a predetermined distance and/or location from or relative to the shape of the occupant, e.g., outline of the occupant). In one example a visual surrounding of an occupant includes parts of the image that are at a distance of up to 0.5 meters from the occupant in the real world. Distance in meters from the occupant in the real world may be translated to distance from the occupant in the image (e.g., a number of pixels) based on known parameters, such as the resolution of the image sensor being used, field of view of the camera and distance of the camera from the occupant. Distance from the occupant in the image may include distance from an outline of the occupant in the image, e.g., a bounding shape created around the occupant.

In another embodiment the visual surrounding of the occupant includes objects (e.g., chair 107) or parts of objects, detected in proximity to the shape of the occupant in the image, typically at a predetermined distance from and/or location relative to the shape of the occupant in the image (e.g., relative to a bounding shape of the occupant).

Processor 102 may detect an object (or part of an object) in proximity to the occupant's shape by detecting the shape of an object. In some embodiments, a shape of a predetermined object or a predetermined shape may be detected.

In one embodiment proximity of a detected shape of an occupant to a predetermined object is determined at processor 102 and based on the shape of the occupant and on the proximity of the occupant to the object processor 102 may output data or a signal. The output signal may include information (e.g., information regarding the body position of the occupant) and/or may be used to control a device. In one example the device is an alarm device. In another example the device may include an electronic device such as a lighting or HVAC (heating, ventilating, and air conditioning) device or other environment comfort devices. The device may be controlled, such as activated or modulated by the signal output according to embodiments of the invention.

In one embodiment a shape of an occupant and/or object is detected from a 2D image. For example, the shape of the occupant 105 in a 2D top view image obtained by image sensor 103 may be similar to the shape of a standing person however based on the visual surrounding 106 of the shape of the occupant and/or based on detection of a chair 107 in close proximity to the shape of the occupant 105 it is determined that the person is sitting, not standing. Data including the information that an occupant is sitting (and optionally including information regarding the location of the sitting occupant) may be output. Alternatively and/or in addition, a signal (e.g., an alarm signal or a signal used to control another device) may be generated based on the determined body position of the occupant in the image.

In another example, it may be determined from the shape of the occupant in the image (optionally together with the visual surrounding of the shape of the occupant), that the occupant body position is a lying or sitting down position. Based on proximity of the lying or sitting occupant to a bed or chair it may be determined if the occupant is lying on a bed or sitting on a chair, in which case no data or signal may be output from processor 102. If the lying or sitting occupant is not proximate a bed or chair it may be determined that the occupant fell, in which case an alarm signal may be output by processor 102.

Proximity of visual surroundings (e.g., proximity of a predetermined object or part of a predetermined object) may be determined or measured in terms of image pixels and/or may be determined or measured in terms of real-world locations of an occupant relative to the real-world surroundings of the occupant (which may then be translated to pixels in the image, as described above).

Typically, the image sensor 103 or camera is at a known distance from and in parallel to a surface such as the floor of room 104 on which objects and occupants are located. Real-world locations of an occupant (or object) may be determined from detecting a location of an occupant (or object) on a floor in the image. The location on the floor in the image may then be transformed to a real-world location by processor 102 or by another processor, by using the known distance of the camera from the floor, for example, in methods of projective geometry. The real-world location may be represented as a coordinate or other location representation.

Processor 102 may run shape detection/recognition algorithms to detect the shape of the occupant and/or the shape of objects in the space. For example, shape detection/recognition algorithms may include an algorithm which calculates features in a Viola-Jones object detection framework. In another example, the processor 102 may run a machine learning process to detect a shape of the occupant and/or of other objects. For example, a machine learning process may run a set of algorithms that use multiple processing layers on an image to identify desired image features (image features may include any information obtainable from an image, e.g., the existence of objects or parts of objects, their location, their type and more). Each processing layer receives input from the layer below and produces output that is given to the layer above, until the highest layer produces the desired image features. Based on identification of the desired image features a shape of an occupant or other object may be determined enabling the system to detect a shape of an occupant or other object.

In one embodiment the image sensor 103 is configured to obtain a top view of a space. For example, a camera including image sensor 103 may be located on a ceiling of room 104 typically in parallel to the floor of the room, to obtain a top view of the room or of part of the room 104. Processor 102 may run processes to enable detection of occupants, such as people, from a top view, e.g., by using rotation invariant features to identify a shape of a person or by using learning examples for a machine learning process including images of top views of people or other types of occupants.

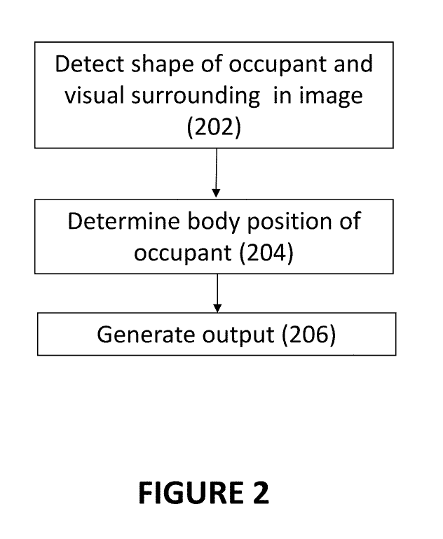

In one embodiment, a shape of an occupant is detected in an image of a space and the body position of the occupant is determined based on the shape of the occupant and based on a visual surrounding of the shape of the occupant in the image. In an example of this embodiment, which is schematically illustrated in FIG. 2, a method for analysis of an imaged scene includes detecting a shape of an occupant and its visual surrounding in an image (202) and determining the body position of the occupant based on the shape of the occupant and the visual surrounding of the shape of the occupant in the image (204). An output (206) may then be generated based on the determined body position of the occupant.

The image may be a top view 2D image of a space, such as room 104.

In some embodiments based on the body position of the occupant no output is generated. For example, in a hospital setting where patients are supposed to be lying in bed, detection of a lying person may generate no output whereas detection of a standing person may cause a signal (e.g., an alarm) to be output.

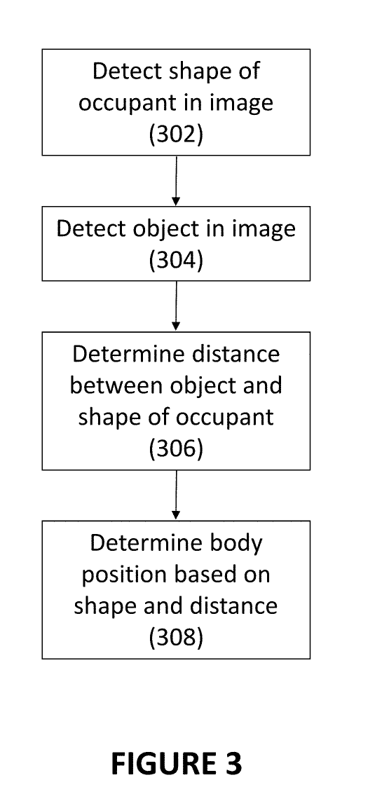

In one embodiment the visual surrounding of the shape of the occupant includes at least one object or part of an object. In one exemplary embodiment, which is schematically illustrated in FIG. 3, a shape of an occupant is detected in an image (302). An object (one or more) or part of an object is also detected in the image (304). The distance between the object and the shape of the occupant is determined (306) and the body position of the occupant is determined based on the shape of the occupant and on the distance between the object and the shape of the occupant (308).

The object (e.g., one or more pieces of furniture such as a bed, chair or desk, or parts of furniture such as arm rests, desk corners, etc.) may be detected in the image using known object detection techniques, e.g., using shape or pattern detection techniques. Thus, the method may include detecting a shape of the object in the image.

The distance between the object and the shape of the occupant may be the distance between the object and the shape of the occupant in the image and/or a real-world distance between the object and the occupant.

In some embodiments the distance between the object and the shape of the occupant may be determined based on the shape of the object. For example, the distance may be measured from an outline of the occupant (e.g., a bounding shape created around the occupant) to an outline (e.g., bounding shape) of the object. In another example the distance may be measured from a center of a shape of an occupant to a center of a shape of an object. Other methods may be used to measure distance in the image between the occupant and object.

In one example, detecting a shape of an occupant (e.g., a lying person) and detecting a partially occluded object (e.g., a partially occluded bed) may mean that the occupant is hiding part of the object in the image and is thus in close proximity to the object. The partially occluded object may be detected based on its shape.

In another example, a shape of a lying person is detected in an image of the room. A bed (or part of a bed or a partially occluded bed) is detected in the same or other images of the room. If the distance between the lying person and the bed is above a predetermined threshold (indicating that the person is not lying on the bed) then an alarm signal may be output. If the distance of the lying person from the bed is below the predetermined threshold (indicating that the person is lying on the bed) then a different signal or no signal is output.

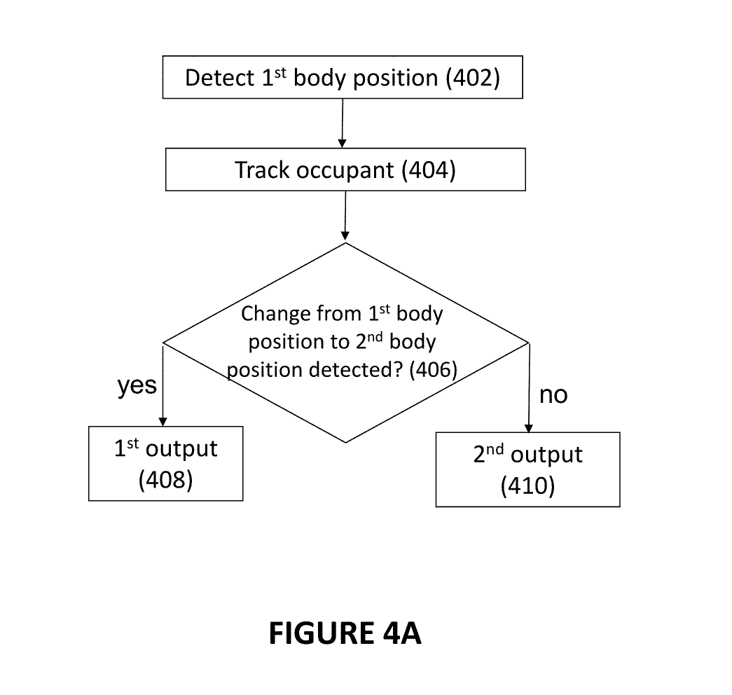

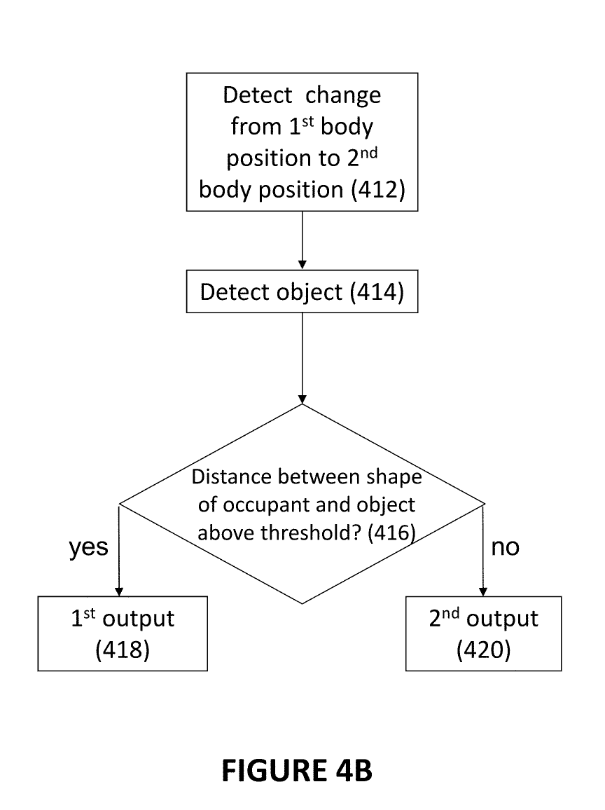

In one embodiment, which is schematically illustrated in FIG. 4A, the method includes detecting a first body position of the occupant in at least one image of the space (402) and tracking the occupant (404), for example by tracking the shape of the occupant. The method further includes detecting a change from the first body position to a second body position of the tracked occupant in subsequent images of the space and outputting a signal based on the detection of the change. For example, if a change from the first body position to a second body position is detected (406) then a first output is generated (408) and if no change from the first body position to a second body position is detected (406) then a second output (e.g., a different output or no output) is generated (410).

Detecting a change from the first body position to a second body position may include detecting the first body position in a first image of the space and detecting the second body position in at least one subsequent image of the space. In one embodiment a time period between the first image and the subsequent image is below a predetermined threshold. Thus, if, for example, a first body position (e.g., standing) is detected in a first image and a second body position (e.g., lying) is detected in a second image obtained many minutes after the first image then no output is generated however if the second image is obtained a few seconds after the first image then an output is generated.

In another embodiment of the invention, which is schematically illustrated in FIG. 4B, the method includes detecting a change from the first body position (e.g., standing) to a second body position (e.g., lying) in images of the space (412). The method further includes detecting an object (e.g., bed) in an image of the space (414) and outputting a signal based on the detected change and based on the distance between the shape of the occupant in the second body position and the object. For example, if the distance between the shape of the occupant in the second body position (lying) and the object (bed) is below a predetermined threshold (416) (e.g., an occupant is lying on the bed) then a first signal is output (e.g., no signal) based on the detection of the change (418) and if the distance between the shape of the occupant in the second body position and the object is above the predetermined threshold (416) (e.g., the occupant is lying far from the bed) then a second signal is output (e.g., an alarm) based on the detection of the change (420).

In some embodiments the method includes detecting a shape of the occupant in the image of a space, detecting motion of the occupant and determining the body position of the occupant based on the shape of the occupant and based on the motion of the occupant.

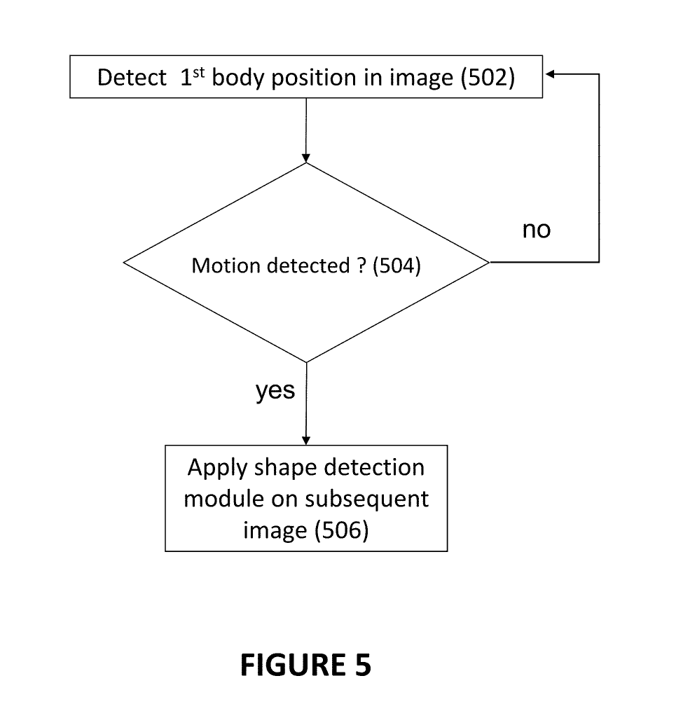

In some embodiments detecting a change from the first body position to the second body position includes detecting motion. In one exemplary embodiment, which is schematically illustrated in FIG. 5, a first body position is detected in an image of a space (502). If motion is detected in subsequent images (504) then a shape detection module is applied (506) on the subsequent images to detect a second body position in at least one of the subsequent images. If no motion is detected, then new images are analyzed to detect the first body position.

In some embodiments the motion is a predetermined motion, namely motion having predetermined characteristics (e.g., motion in a predetermined direction and/or speed).

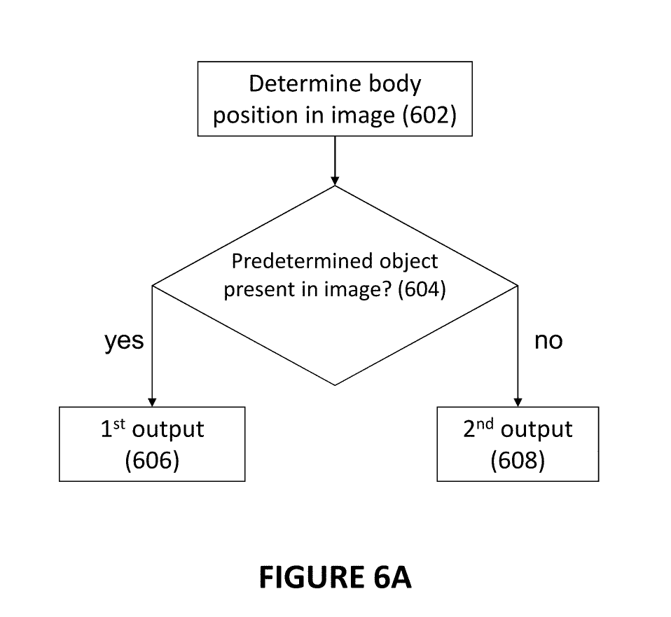

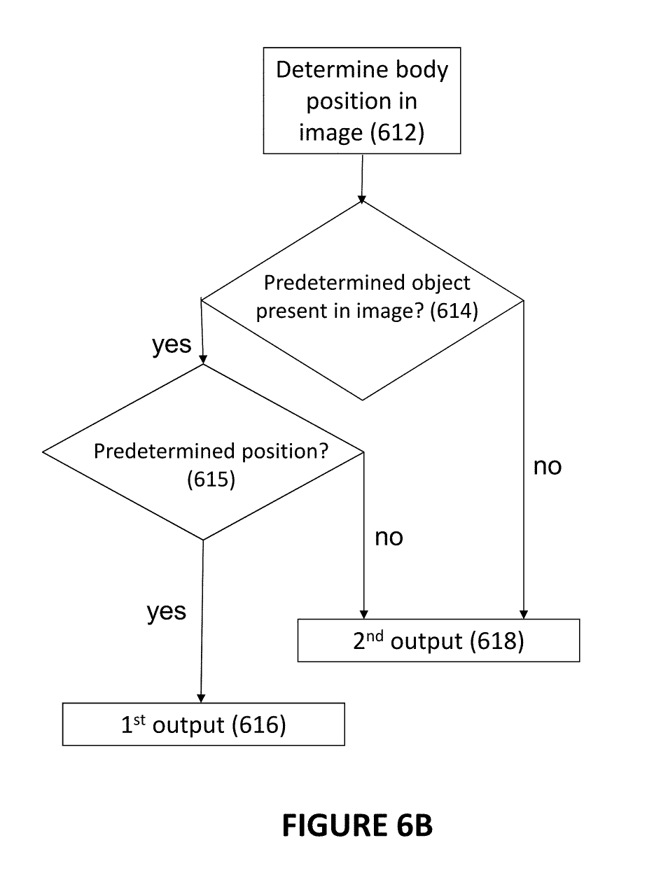

In one embodiment, which is schematically illustrated in FIG. 6A, a method for image analysis includes determining a body position of an occupant in an image of a space (602) and determining presence of a predetermined object in the image (604). An output is generated based on the determined body position of the occupant and based on the determination of presence of the predetermined object in the image. For example, if a certain body position is determined and the predetermined object (one or more) is present in the image (604) then a first signal is output (606). If the predetermined object is not present in the image (604) then a second different or even no signal is output (608).

Determining a body position of an occupant in an image may be done by detecting the shape of the occupant and determining the body position of the occupant based on the determined shape, e.g., as described above. In another example determining a body position of an occupant in an image may be done by detecting a motion of the occupant and determining the body position of the occupant based on the shape of the occupant and based on the motion of the occupant. In some cases, the motion is a predetermined motion, e.g., motion having predetermined characteristics (e.g., motion in a predetermined direction and/or speed).

Determining presence of a predetermined object may be done by detecting and identifying an object as the predetermined object. Another method may include detecting a predetermined shape and determining presence of a predetermined object based on the detection of the predetermined shape.

In one embodiment, which is schematically illustrated in FIG. 6B, the method includes outputting a signal (e.g., step 606, in FIG. 6A) if the body position of the occupant is a predetermined body position and outputting a different signal or no signal (e.g., step 608, in FIG. 6A) if the body position is not the predetermined body position.

In one example the method may include determining a body position of an occupant in an image of a space (612) and determining presence of a predetermined object in the image (614). If the predetermined object (one or more) is present in the image (614) and if the body position is a predetermined body position (615) then a first signal is output (616). If the predetermined object is not present in the image (614) and/or the body position is not the predetermined body position (615) then a second signal (or no signal) is output (618).

In one embodiment the first and/or second signal may include information regarding the body position of the occupant. In another embodiment the first and/or second signal may control a device.

The presence of the object in the image may be determined based on detecting a shape of the object in the image (e.g., as described above).

In one example the predetermined object is a piece of furniture such as a chair and the predetermined body position is of a sitting person. In this example if a chair is detected in a first image of a space, a body position of a sitting person will be searched for in the first image or in subsequent images (e.g., images obtained within a predetermined time frame after the first image). If the body position of a sitting person is detected in the first and/or subsequent images then information that a person is sitting in the detected chair may be transmitted and/or a light source located above the chair may be turned on.

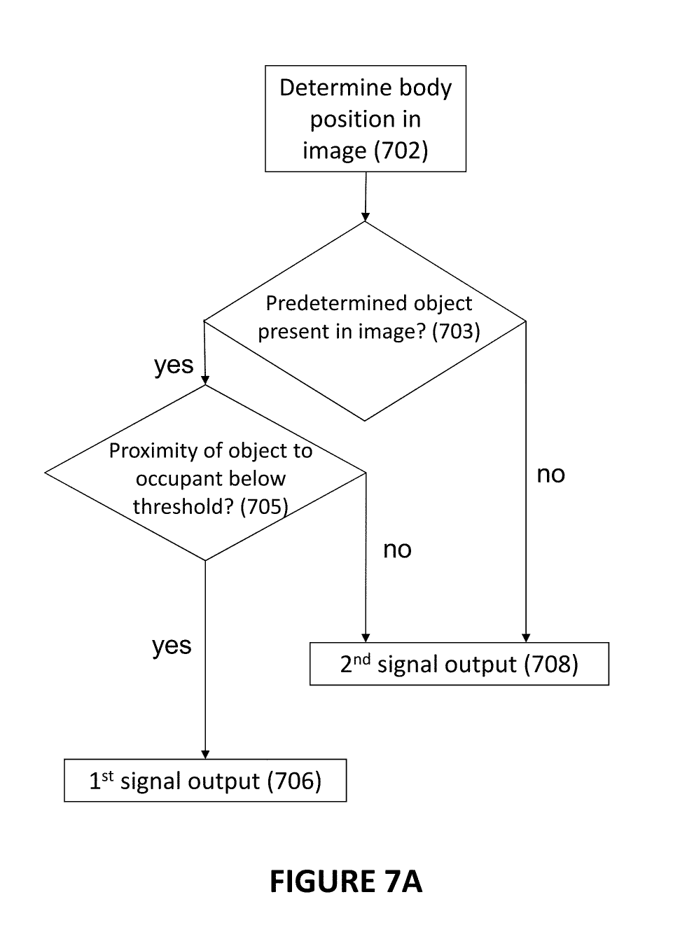

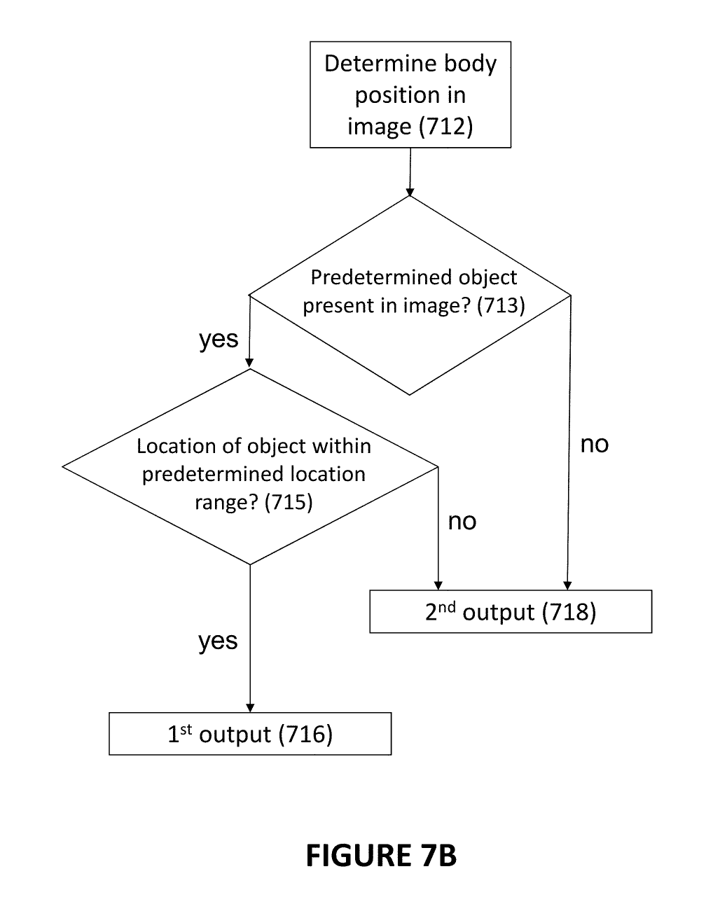

In some embodiments, which are schematically illustrated in FIGS. 7A and 7B, an output is generated based on proximity and/or location of an occupant in a predetermined body position, relative to the object.

In one example, illustrated in FIG. 7A, a body position of an occupant is determined in an image of a space (702). If it is determined that a predetermined object is present in images of the space (703) and if the proximity of the predetermined object to the occupant is below a predetermined threshold (705), then a first signal is output (706). If the predetermined object is not present in the image (703) or if the object is present but the proximity of the object to the occupant is above the predetermined threshold (705), then a second signal may be output (708).

Proximity of the occupant to the predetermined object may be determined or measured in terms of image pixels and/or may be determined or measured in terms of real-world locations of an object relative to the real-world location of the occupant or in terms of location of the object in the image to the location of the occupant in the image, as described above.

In another example, illustrated in FIG. 7B, a body position of an occupant is determined in an image of a space (712). If it is determined that a predetermined object is present in images of the space (713) and if the location of the predetermined object relative to the occupant is within a predetermined location range (715), then a first signal is output (716). If the predetermined object is not present in the image (713) or if the object is present but the location of the object relative to the occupant is not within the predetermined location range (715), then a second signal may be output (718).

A location range may include a direction (e.g., as determined by a range of angles) from the object (e.g., from the center of the shape of the object). Location of the predetermined object relative to the occupant may be determined or measured in terms of image pixels and/or may be determined or measured in terms of real-world locations of an object relative to the real-world location of the occupant or in terms of location of the object in the image to the location of the occupant in the image, as described above.

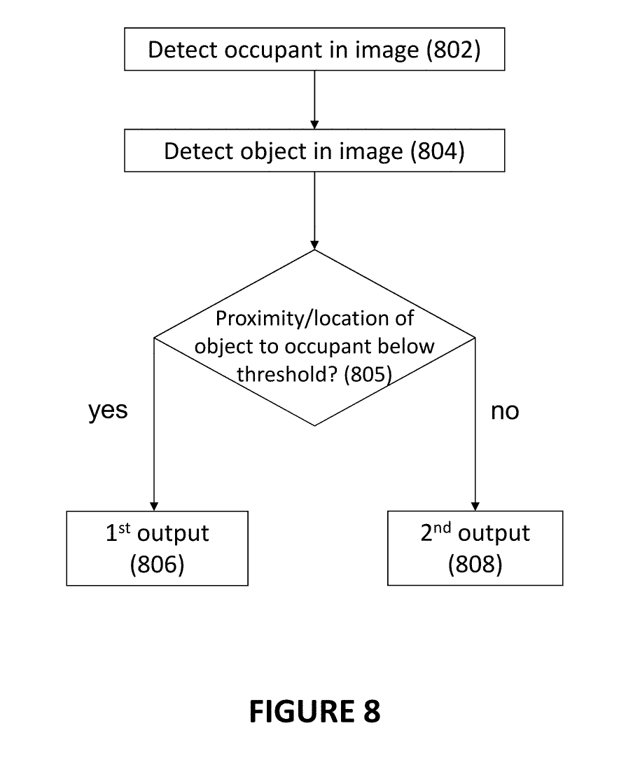

In one embodiment an occupant and an object are detected in an image (one or more images) of a space and a signal is output based on the proximity and/or location of the occupant (regardless of the body position of the occupant) relative to the object. In one embodiment, which is schematically illustrated in FIG. 8, a method for analyzing an image includes detecting an occupant in an image (802) and detecting an object in the image (804). An object may be one or more pieces of furniture or other fixtures in a room, for example.

If proximity of the occupant to the object is below a predetermined threshold and/or the location of the occupant relative to the object is within a predetermined location range (805), a first signal is output (806) if the proximity of the occupant to the object is above the predetermined threshold and/or the location of the occupant relative to the object is not within the predetermined location range (805), a second signal is output (808). Either the first or second signal may include no signal.

In one example, the predetermined threshold is large enough such that if an occupant and predetermined object are detected in the same image, the first signal is output.

The distance between the object and the occupant may be the distance between the object and the occupant in the image and/or a real-world distance between the object and the occupant, as described above.

In some embodiments an output is generated based on proximity of the occupant to the object and based on a body position of the occupant. The body position of the occupant may be determined based on a shape of the occupant in the image, e.g., as described above.

What is claimed is:

1. A method comprising:
detecting a shape of an occupant in an image of a space;
determining a body position of the occupant based on the shape of the occupant and based on a visual surrounding of the shape of the occupant in the image; and
generating an output based on the body position of the occupant.

2. The method of claim 1 wherein the visual surrounding of the shape of the occupant comprises parts of the image that are at a predetermined distance from the shape of the occupant in the image.

3. The method of claim 1 wherein the visual surrounding of the shape of the occupant comprises parts of the image that are at a predetermined location relative to the shape of the occupant in the image.

4. The method of claim 1 wherein the visual surrounding of the shape of the occupant comprises at least one object in the image.

5. The method of claim 4 comprising detecting a shape of the object in the image.

6. The method of claim 4 comprising:
determining a distance between the object and the shape of the occupant; and
determining the body position of the occupant based on the shape of the occupant and on the distance.

7. The method of claim 6 wherein the distance comprises a distance between the object and the shape of the occupant in the image.

8. The method of claim 6 wherein the distance comprises a real-world distance between the object and the occupant.

9. The method of claim 1 wherein the object comprises one or more pieces of furniture.

10. The method of claim 1 comprising:
determining a first body position of the occupant in at least one image of the space;
tracking the occupant throughout subsequent images of the space;
detecting a change from the first body position to a second body position of the tracked occupant; and
generating an output based on the detection of the change.

11. The method of claim 10 wherein detecting a change from the first body position to a second body position comprises detecting the first body position in a first image of the space and detecting the second body position in a subsequent image of the space.

12. The method of claim 11 wherein a time period between the first image and the subsequent image is below a predetermined threshold.

13. The method of claim 10 wherein detecting a change from the first body position to a second body position comprises:
determining the first body position in an image of the space;
detecting motion of the occupant in subsequent images of the space;
based on detection of the motion detecting the change.

14. The method of claim 13 comprising based on detection of the motion applying a shape detecting module to determine the second body position.

15. The method of claim 13 wherein the motion is a predetermined motion.

16. The method of claim 10 comprising:
detecting an object in the at least one of image of the space;
generating a first output based on the detection of the change and if a distance between the shape of the occupant and the object is below a predetermined threshold; and
generating a second output based on the detection of the change and if a distance between the shape of the occupant and the object is above a predetermined threshold.

17. The method of claim 1 wherein the image of the space is a top view 2D image of the space.

18. A system comprising a processor to determine a body position of an occupant based on a shape of the occupant and on visual surrounding of the shape of the occupant in an image.

19. The system of claim 18 comprising a processor to control a device based on the body position of the occupant.

20. The system of claim 18 comprising an image sensor in communication with the processor, the image sensor to obtain the image.
